(19) United States
(12) Patent Application Publication
(10) Pub. No.: US 2015/0362951 A1
(43) Pub. Date: Dec. 17, 2015

(54) THEMATIC COORDINATION OF AN INFORMATION DEVICE AND A WEARABLE BAND

(71) Applicant: WOLF MOUNTAIN IP, LLC, ASHEVILLE, NC (US)

(72) Inventors: Scott Hicks, Asheville, NC (US); Brenner Hicks, Asheville, NC (US)

(21) Appl. No.: 14/833,204

(22) Filed: Aug. 24, 2015

(51) Int. Cl. G06F 1/16; G06F 3/0482

(52) U.S. Cl. CPC G06F 1/163; G06F 3/0482

(57) ABSTRACT

Embodiments relate generally to a portable information device and associated wearable band and, more particularly, to thematic coordination of a portable information device and associated wearable band. One example embodiment includes a portable electronic information device comprising a display and a communication interface configured to receive identification from an attached wearable band—the received identification is used to determine one or more thematic elements intended to correspond with at least one visual attribute of a surface of the wearable band, and one or more of these thematic elements are presented on the information device display. Another example embodiment includes a wearable band comprising an interface configured for electrically coupling to a portable electronic information device—communication over the interface is used by the information device, the wearable band, or both to instantiate thematic coordination between the wearable band and the information device. Additionally, a further example embodiment includes a method for a portable electronic information device to obtain and utilize, from a remote server, information associated with one or more thematic elements intended to correspond with a coupled wearable band.

### BACKGROUND

Embodiments relate generally to a portable information device and an associated wearable band and, more particularly, to thematic coordination of a portable information device and an associated wearable band.

### SUMMARY

In one example embodiment, a portable electronic information device is provided, wherein the information device comprises a power source, a communication interface configured to use electricity from the power source to electrically couple with a wearable band that is attachable to, and removable from, the information device, a display, a memory configured to store software instructions, and a processor configured to access the software instructions from the memory. The processor executes the accessed software instructions to receive identification from the wearable band via the interface, use the received identification to determine one or more thematic elements intended to correspond with at least one visual attribute of a surface of the wearable band, and present the one or more thematic elements on the display. Additionally, the portable electronic information device may further comprise an input device configured to accept user input, wherein the processor is further configured to execute the software instructions from the memory to provide multiple choices via the display to a user of the information device, wherein two or more thematic elements have been determined, and wherein the multiple choices relate to the two or more thematic elements; receive user input via the input device, wherein the user input is associated with one or more of the multiple choices; and use the user input received via the input device to select one or more thematic elements for presentation on the display. The information device may be an intelligent watch, a fitness tracker, or a combination thereof.

In another example embodiment, a wearable band is provided, wherein the wearable band comprises an interface configured for electrically coupling to a portable electronic information device. The wearable band is configured to communicate via the interface with the electrically coupled information device, and the interface communication is used by the information device, the wearable band, or both to instantiate thematic coordination between the wearable band and the information device. Additionally, the wearable band may further comprise a memory configured to store software instructions and a processor configured to access the software instructions from the memory. The processor executes the accessed software instructions to receive identification from the information device via the interface; use the received identification to determine one or more thematic elements intended to correspond with the information device; and instantiate the thematic coordination by presenting the one or more thematic elements on the band display. Alternatively the thematic coordination may instead be instantiated through the information device communicating via the interface to cause the presentation of one or more thematic elements on a band display, wherein the one or more thematic elements are selected by the information device to correspond with the information device. The wearable band may either be configured to be attachable to, and removable from, the information device, or instead be integrated with the information device and therefore not intended to be easily removable by a user.

In a further example embodiment, a method performed by a portable electronic information device is provided, the method comprising receiving identification from an electrically coupled wearable band, wherein the wearable band is attachable to, and removable from, the information device; querying a remote server via a wireless connection by providing the identification or a representation thereof to the server; receiving from the server information associated with one or more thematic elements intended to correspond with the coupled wearable band; using the received information, selecting one or more associated thematic elements; and presenting the selected one or more thematic elements on a display of the portable electronic information device. The method may further comprise providing multiple choices via the display to a user of the information device when the server information indicates two or more thematic elements, wherein the multiple choices relate to the two or more thematic elements; receiving user input via an input device of the information device, wherein the user input is associated with at least one of the multiple choices; and selecting at least one thematic element for presentation on the display based upon the user input received via the input device.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Additional features and advantages of claimed subject matter will be set forth in the description which follows, and in part will be obvious from the description, or may be learned by the practice of embodiments. The features and advantages of various embodiments may be realized and obtained by means of the instruments and combinations particularly pointed out in the appended claims. These and other features of example embodiments will become more fully apparent from the following description and appended claims, or may be learned by the practice of embodiments as set forth hereinafter.

### BRIEF DESCRIPTION OF THE DRAWINGS

To further clarify the above and other advantages and features of inventive embodiments, a more particular description of subject matter will be rendered by reference to specific embodiments thereof which are illustrated in the appended drawings. It is appreciated that these drawings depict only example embodiments and are therefore not to be considered to limit scope. Example embodiments will be described and explained with additional specificity and detail through the use of the accompanying drawings in which:

FIG. 1 is a front view of a user system including a portable electronic information device and a wearable band in accordance with an example embodiment;

FIG. 2 illustrates an example communication system including a user system;

FIG. 3 illustrates a block diagram illustrating a suitable computing environment in which several embodiments may be implemented;

FIG. 4 is a front view of a user system illustrating coordinated thematic elements in accordance with another example embodiment;

FIG. 5 is a front view of a user system illustrating user choice in selection of thematic elements in accordance with a further example embodiment; and

FIG. 6 illustrates an example method for theme coordination between a portable electronic information device and a wearable band.

### DETAILED DESCRIPTION

Embodiments will now be described more fully hereinafter with reference to the accompanying drawings in which example embodiments are shown. However, embodiments may be in many different forms and should not be construed as limited to the embodiments set forth herein. These example embodiments are provided so that this disclosure will be both thorough and complete, and will fully convey the scope to those skilled in the art. Like reference numbers refer to like elements throughout the various drawings.

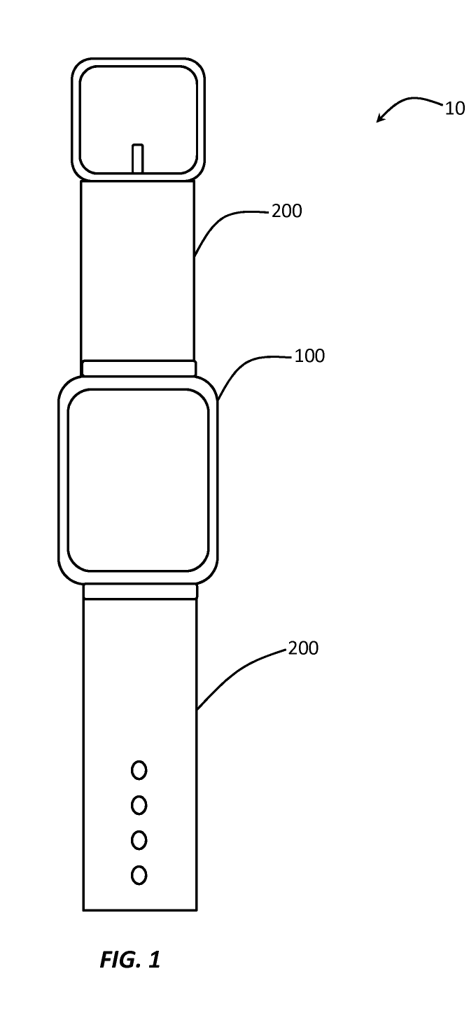

FIG. 1 illustrates a front view of an example user system 10 in accordance with an example embodiment. The user system 10 includes a portable electronic information device 100 and an attached wearable band 200. The information device 100 may be an intelligent watch, a fitness tracker, or a combination thereof. The wearable band 200 may be configured to be attachable to, and removable from, the information device 100. Alternatively, the wearable band 200 may instead be integrated with the information device 100 and therefore not intended to be easily removable by a user of the user system 10. As will be described in further detail in reference to other figures, in some embodiments providing different coordinated themes between the information device 100 and the wearable band 200 does not require changing the wearable band 200, in which embodiments the wearable band 200 does not need to be removable. The wearable band 200 is intended to be worn by a user of the user system 10 on a user body part such as a wrist, an ankle, an upper arm, or other areas. While the wearable band 200 as illustrated in FIG. 1 shows adjustment holes and a buckle with a prong for insertion into the holes, this illustrated configuration is not intended to be limiting, and any type of attachment mechanism such as a clasp would suffice. The wearable band 200 may also be configured in other ways, such as being one continuous flexible strap that can be stretched over a user body part.

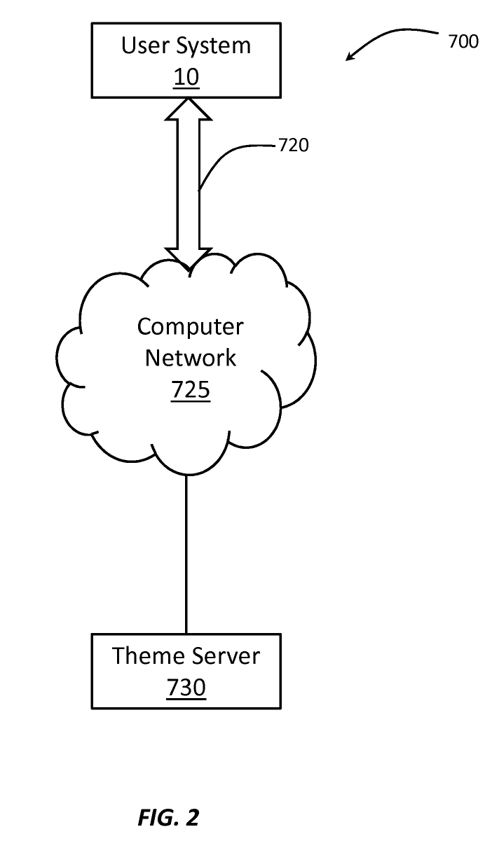

FIG. 2 illustrates an example communication system 700. The communication system 700 generally provides one or more user system users (not shown) with a theme coordination service (not shown). The communication system 700 may include a user system 10 communicatively coupled to a remote theme server 730 via a computer network 725. The coupling between the theme server 730 and the user system 10 may enable the user to access at least some portion of a theme coordination service stored or otherwise available on the theme server 730. Details of the theme server 730 are not shown, but the theme server 730 may include a controller and a memory. The controller may include a microprocessor which executes a theme server application, and this theme server application may include data, instructions, applications, or computer programs stored in memory. The theme server application may vary as necessary to implement the theme coordination service.

The user system 10 in FIG. 2 may include thematic coordination client software (not shown) to access the theme server 730. The user system 10 communicates with the theme server 730 over a wireless connection 720 via the computer network 725. The computer network 725 relates to a collection of devices interconnected by communication channels that allow sharing of information among the interconnected devices. In this example embodiment, the computer network 725 may be or include any wired or wireless network technology such as optical fiber, electrical cables, Ethernet, radio wave, microwaves, infrared transmission, wireless internet, communication satellites, cellular telephone signals, or an equivalent networking signal that interfaces with devices to create a network. Specifically, in some embodiments, the user system 10 communicates with the theme server 730 via the Internet. In a preferred embodiment, the information device 100 of the user system 10 communicates wirelessly over the wireless connection 720, such as via Bluetooth, IEEE 802.11 Wi-Fi, or another wireless technology. The user system 10 may wirelessly couple with any other type of communication device, such as a cellular phone, a Wi-Fi tablet, or an 802.11 access point, over the wireless connection 720 to effect communication via the computer network 725 to the theme server 730.

In FIG. 2, one user system 10 is operably connected to communicate with the theme server 730 via the computer network 725. However, in alternative embodiments a plurality of user systems 10, which may include various types of user systems 10, may simultaneously communicate with the theme server 730. Additionally or alternatively, the communication system 700 may include multiple theme servers 730 which are operably connected to communicate information among the multiple theme servers 730 and/or to communicate information among various user systems 10 operably connected to communicate with the theme servers 730.

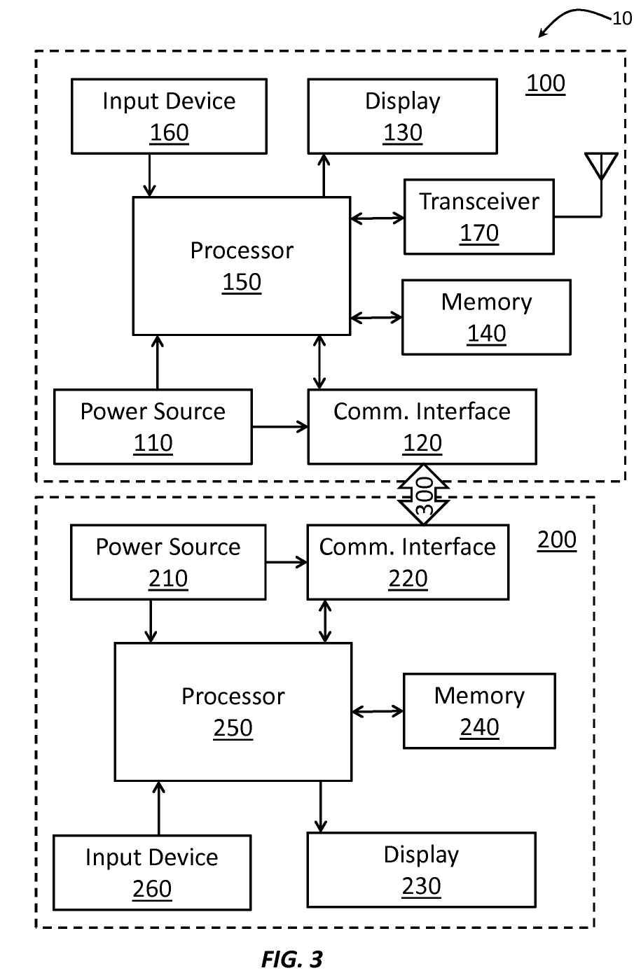

FIG. 3 illustrates a block diagram illustrating a suitable computing environment in which several embodiments may be implemented. FIG. 3 illustrates an example user system 10, including a portable electronic information device 100 and a wearable band 200.

As illustrated in FIG. 3, the information device 100 includes a power source 110, a communication interface 120, a display 130, a memory 140, a processor 150, and an input device 160. The processor 150 is a controller that performs control and processing associated with operation of the information device 100, such as user interface interaction via the display 130 and the input device 160, along with data communications via the communication interface 120. The power source 110 is preferably a battery, though any other input electrical power supply may be used. The power source 110 is used to power the processor 150 and to supply electricity to the communication interface 120, either directly, or indirectly through the processor 150. The memory 140 may include at least one type of non-transitory storage medium including a hard disk type, a card-type memory (e.g., SD or XD memory, etc), a flash memory, a Random Access Memory (RAM), a Read-Only Memory (ROM), and the like. The memory 140 is configured to store software instructions, and the processor 150 is configured to access the software instructions from the memory 140 to execute the accessed software instructions.

The display 130 is used to output information processed in the information device 100 by the processor 150—this information output is presented visually to a user of the information device 100. For example, the processor 150 may output one or more images, text, icons, and/or other information via the display 130 to provide a user interface (UI), also known as a graphical user interface (GUI). The display 130 may also be used to visually present one or more background user interface elements such as a color scheme, an image, a visual pattern, text, and the like, with any background UI element being at least partially covered and obscured by one or more presented foreground UI elements. The display 130 may also be used to present menus, prompts, text entry areas, list dropdowns, and other information input requests to the user—the user can provide information input to the processor 130 via the input device 160. The input device 160 may take any form that allows for a user to provide information input to the information device 100, such as a keyboard, pointing device, microphone (for speech recognition), joy stick, touch pad, touchscreen, or the like. If the display 130 is configured to have a touchscreen, the touchscreen is used as the input device 160.

The information device 100 may also optionally include a wireless transceiver 170 for communicating wirelessly via the wireless connection 720 of FIG. 2, such as via Bluetooth, IEEE 802.11 Wi-Fi, or another wireless technology. The information device 100 may wirelessly couple over the wireless connection 720 with any other type of communication device, such as a cellular phone, a Wi-Fi tablet, or an 802.11 access point, with this other communication device being a component of the computer network 725 of FIG. 2.

As also illustrated in FIG. 3, the wearable band 200 includes a communication interface 220, a memory 240, and a processor 250, at the least. The communication interface 120 of the information device 100 uses electricity from the power source 110 (either directly or via the processor 150) to electrically couple with the communication interface of the wearable band 200. The information device 100 and the wearable band 200 are preferably also mechanically coupled, though this mechanical coupling may be independent and unrelated to the electrical coupling via the interfaces 120 and 220. The information device communication interface 120 and the band communication interface 220 may use any communication hardware and/or software to communicate information to and from the other respective interface via a communication channel 300. An electrical connection between the two interfaces 120 and 220 can be made via electrical pins such as via Universal Serial Bus (USB) or another communication bus, via electromagnets, via radio waves such as through Near Field Communication (NFC), and the like. A protocol used for the communication channel 300 may be standards-based such as USB or may be proprietary to a given type of user system 10. In some embodiments, the wearable band 200 includes only the communication interface 220, the memory 240, and the processor 250—the band 200 may be passive and need not include its own power source 210 because the band 200 may instead use power from the information device 100 from the device interface 120 to power components in the band 200. Alternatively, the band 200 may be active and have an on-board power source 210 to provide power to components in the band 200. Identification pertaining to the band 200 and/or visual attributes thereof may be stored in the memory 240, and the processor 250 may communicate the identification via the band interface 220 and channel 300 to the device interface 120. The memory 240 may also be configured to store software instructions, and the processor 250 may be configured to access the software instructions from the memory 240 to execute the accessed software instructions.

The wearable band 200 may optionally also include an input device 260 that may be used by a user of the band 200 to input information for processing by the processor 250. The band 200 may further include a band display 230, where the band display 230 is separate from the information device display 130. The band processor 250 may output one or more images, text, icons, and/or other information via the band display 230 to provide a user interface.

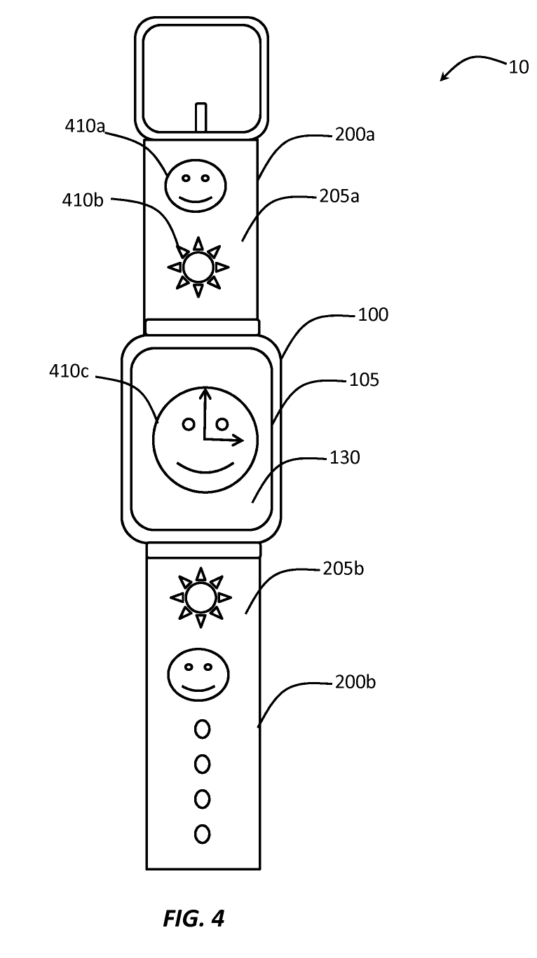

Referring now to FIG. 4, a front view of an example of the user system 10 is illustrated with coordinated thematic elements in accordance with an example embodiment. A surface 205 of the wearable band 200 has at least one visual attribute, also considered to be a thematic element, such as a color scheme, one or more visual patterns, one or more rendered images, or the like. The color scheme could be one color or a combination of two or more colors. A particular visual pattern could be any type of repeated decorative design, such as stripes, dots, or the like. The band 200 may have rendered thereon one or more images such as the example images from FIG. 4 illustrated as thematic elements 410a (smiley face) and 410b (sun) on band surface 205a. Though in the black and white drawing of FIG. 4, the surface 205a has a white color, the surface 205a could instead have any other color (e.g., red, brown, black, etc.), and likewise the surface 205a could include a visual pattern. The thematic elements 410a and 410b could include non-black/white colors as well. In FIG. 4, the wearable band 200 is illustrated as having two separate components, top portion 200a and bottom portion 200b—alternative embodiments include a continuous band without separate portions. Band surface 205b in this example also includes the same images as on the other band surface 205a. The thematic elements 410a and 410b presented on the band surface 205a are visual attributes that may be formed by material of the band 200, by printed or painted portions on the band surface 205a, and/or by rendering presented by the optional band display 230. As illustrated in FIG. 4, the display 130 of the information device 100 is at least a portion of a surface 105 of the information device 100, and the display 130 has visually presented thereon another thematic element 410c—this thematic element 410c is a background smiley face image that corresponds thematically with at least the smiley face thematic element 410a on the band surface 205a. In the example embodiment illustrated, the information device 100 is a watch, and corresponding watch hands are displayed superimposed over the thematic element 410a presented in the background on the display 130. All examples are representative and are not meant to be restrictive.

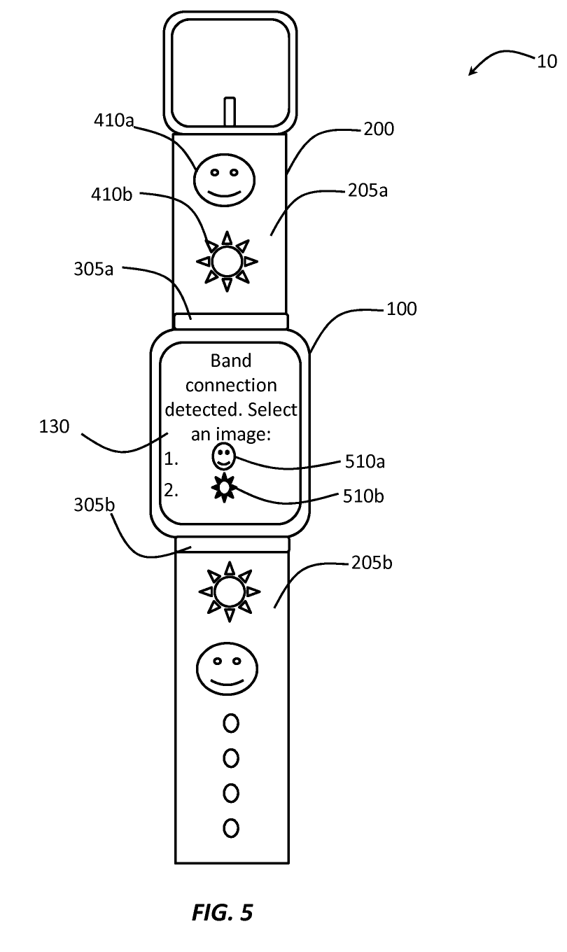

Turning now to FIG. 5, a front view of an example of the user system 10 is illustrated with multiple displayed user choices for selection of one or more thematic elements. In FIG. 5, physical connections 305a and 305b are shown to indicate physical connection between the information device 100 and the band 200. The communication channel 300of FIG. 3 may be established through one or both of these physical connections 305a and 305b. The communication channel 300 may also be wireless and therefore not require any type of mechanical connection between the information device 100 and the band 200. The physical connections 305a and 305b are illustrated in example locations, and there are multiple different alternative physical connection options, such as having one physical connection 305 between a back face of the information device 100 and a surface 205 of the wearable band 200 (this alternative is not illustrated). The physical connection 305 between the information device 100 and the wearable band 200 mechanically couples the band 200 to the information device 100 in any manner to securely bind the two together. For example, at least one portion of the band 200 may accommodate a quick-release pin for insertion into two lug holes in a body of the information device 100. Alternatively, in another example, the information device 100 and the band 200 may be securely connected through magnetism. Any other type of mechanical connection suffices for the physical connection 305, such as a clip, a snap, a tab, a latch, a wrap, and the like. The physical connection 305 between the information device 100 and the wearable band 200 may be constructed to allow the wearable band 200 to be attachable to, and removable from, the information device 100; or instead, the physical connection 305 may be more permanent and therefore not intended to allow the band 200 to be easily removable from the information device 100. A more permanent physical connection 305 may be implemented such as through use of screws, an adhesive substance such as glue, soldering, and the like. The wearable band 200 may instead be a continuous extension of a body of the information device 100 itself.

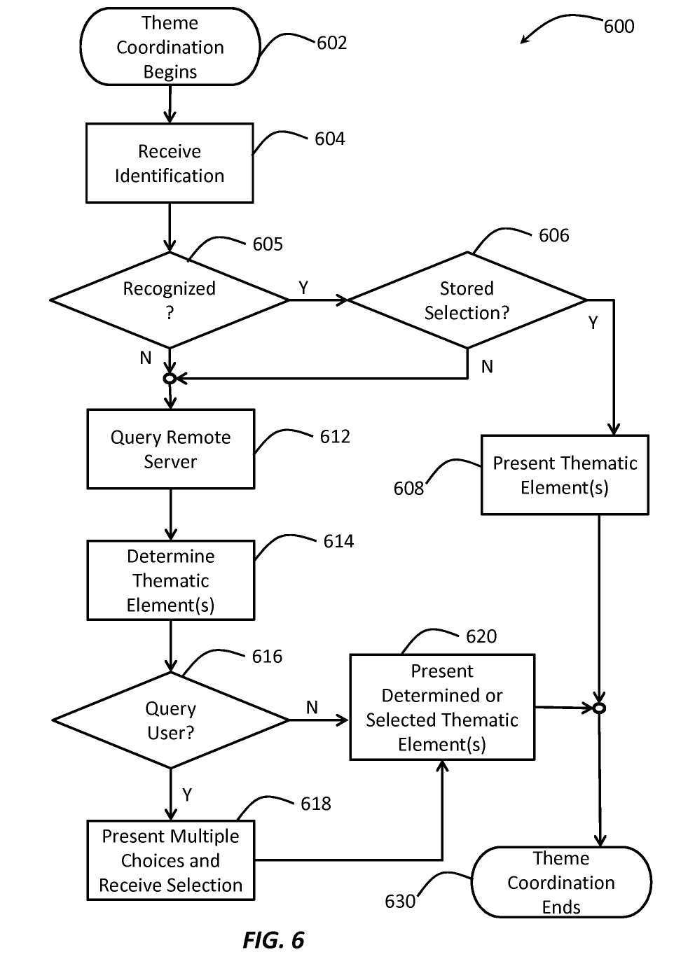

Referring to FIG. 6, an example method 600 for theme coordination between the portable electronic information device 100 and the wearable band 200 is illustrated in a flow diagram. The method 600 may be performed by the information device 100 with cooperation from the wearable band 200. The information device 100 and the wearable band are each communicatively coupled to a non-transitory computer-readable medium (e.g., the memories 140 and 240 of FIG. 3, respectively) having stored thereon or encoded therein programming code or instructions that are executable by a processor (e.g., the device processor 150 and/or the band processor 250) to perform or cause performance of the method 600. Although illustrated as discrete blocks, various blocks may be divided into additional blocks, combined into fewer blocks, or eliminated, depending on the desired implementation.

At block 602, theme coordination begins. The method 600 may be initiated in response to one of a variety of triggers. For example, the method 600 may be triggered upon initiation of the communication channel 300 between the device interface 120 and the band interface 220, such as upon establishment of the physical connection 305 of the band 200 with the information device 100. Alternatively, the theme coordination method 600 may begin at block 602 at any other time, such as in response to a user-initiated request through interaction through the input device 160 of the information device 100.

At block 604, theme coordination requires that the communication channel 300 exists, and the band 200 may send identification, such as an identifier of the band 200, to the information device through the communication channel 300. The identification may instead be indicative of one or more visual attributes of the surface 205 of the wearable band 200—the visual attributes may be directly indicative of one or more thematic elements 410 themselves. In any case, at block 605, the information device processor 150 may compare the received identification to earlier-received identification stored in information device memory 140 to determine if the identification is recognized by the information device 100 from an earlier connection. The identification is a collection of multiple computer information units such as bits or bytes. The identification may be a unique identifier that uniquely identifies the particular band 200, or alternatively the identification may instead identify a particular class or group of bands, or as a further alternative the identification may represent one or more visual attributes associated with the surface 205 of the wearable band 200. If the identification is recognized, then at block 606 the information device processor 150 may perform a lookup in information device memory 140 to determine if for the recognized identification there is a stored user selection of at least one thematic element 410 associated with the particular band 200, class or group of band 200, or one or more visual attributes of the surface 205 of the wearable band 200. If there is a stored user selection of at least one thematic element 410, then at block 608 the information device processor 150 may present one or more of the at least one thematic element 410 on the information device display 130, and then theme coordination ends at block 630.

With reference back to FIG. 2, at block 612, the information device 100 may query the remote theme server 730 using the wireless connection 720 via the computer network 725. To query the remote server 730, the information device 100 may provide the identification or a representation thereof to the server 730. The information device 100 may receive from the server 730 information associated with one or more thematic elements intended to correspond with the coupled wearable band 200. The information is a collection of multiple computer information units such as bits or bytes.

Whether or not the information device 100 has queried the theme server 730, at block 614 the information device determines one or more thematic elements 410 that are coordinated to correspond visually with one or more visual attributes of the surface 205 of the band 200. The information device 100 may not need to query the theme server 730, such as if the information device processor 150 determines one or more associated thematic elements 410 by performing a lookup in information device memory 140. For example, if the identification received from the band 200 identifies a particular class or group of bands, then the information device 100 and/or the server 730 may perform a lookup, such as in a data table stored in memory, to find one or more thematic elements 410 that correspond to the class or group of bands—for example, there could be multiple bands associated with a particular sports team by having one or more visual attributes related to the given sports team visually rendered on the bands. For this class or group of bands pertaining to the sports team, associated thematic elements 410 may also relate to the given sports team—the thematic elements 410 could include a color scheme that includes the sports team's colors, and/or the thematic elements 410 could include a logo image for the sports team. If instead, if the identification received from the band 200 identifies one or more particular visual attributes, the information device 100 and/or the server 730 may select one or more thematic elements 410 to correspond to the one or more visual attributes—for example, if the identification identifies a color scheme of red and black along with a pattern of stripes, the associated thematic elements 410 could also include the same color scheme of red and black along with the same pattern of stripes. Even if the memory 140 has stored therein one or more thematic elements 410 that may be used to coordinate visually with the surface 205 of the wearable band 200, the information device 100 may supplement available options for thematic elements 410 by querying the theme server 730 for additional thematic elements 410. Thematic elements 410 may be added over time to a theme coordination service provided by the theme server 730, and so by querying the theme server, the information device 100 can obtain newer thematic elements 410 not previously available.

At block 616, the information device 616 may determine whether or not to query a user of the user system 10 regarding which thematic element(s) 410 to present on the information device display 130. If the user is not queried, such as if there is only one determined thematic element 410, at block 620 the one or more thematic elements 410 may be presented on the information device display 130, and theme coordination ends at block 630.

If instead the user is to be queried, then at block 618 the information device 100 may present multiple choices via the information device display 130 to the user. The multiple choices relate to two or more thematic elements 410 as shown in FIG. 5, where choice 510a is presented as a smiley face image and choice 510b is presented as a sun image—each of choice 510a and 510b corresponds with a visual attribute of the surface 205 of the band 200. Choice 510a is coordinated to thematic element 410a, while choice 510b is coordinated to thematic element 410b. User input is received at the information device 100 via the input device 160, where this user input is associated with one or more of the multiple choices—the user may select just one choice 510 or multiple choices 510 through the input device 160. At block 620 the user input may be used to select one or more thematic elements 410 for presentation on the information device display 130, and theme coordination ends at block 630.

Referring back to FIG. 4 in combination with FIG. 5, user selection of choice 510a in FIG. 5 may result in presentation on the display 130 of the thematic element 410c as illustrated in FIG. 4. Alternatively, the choice 510b may be selected instead, in which case a different thematic element 410 may be presented on the display 130. Because the choices 510 may not be mutually exclusive, in the event that the user selects both choices 510, multiple thematic elements 410 may be rendered on the display 130.

The thematic elements 410 are based on a theme, wherein the theme may pertain to a movie, a television show, a musical act, one or more famous individuals, a color scheme, a visual pattern, an image, or combinations thereof. For example, the wearable band 200 may be visually branded with one or more characters and/or the name of a popular movie—upon coupling with the information device 100, the information device 100 may use identification from the wearable band 200 to present on the display 130 one or more of the same or other characters of the same movie in order to coordinate the theme between the information device 100 and the wearable band 200 for the user system 10. Again, each thematic element 410 used to provide theme coordination may be a color scheme, an image, a visual pattern, or any combination thereof. So for a wearable band 200 with a light blue and yellow Swedish flag rendered on the band surface 205, for example, theme coordination may result in presentation of the same color blue and/or yellow on the information device display 130.

As described in reference to FIG. 3, the wearable band 200 may also include its own display 230, which is separate from the information device display 130. The information device 100 may communicate via communication channel 300 to cause presentation of one or more thematic elements 410 on the band display 230. The band 200, which may include the memory 240 and processor 250 may on its own present one or more thematic elements 410 on the band display 230. Presentation on the band display 230 may be in addition to, or instead of, presentation on the information device display 130. Use of the band display 230 removes the need for a user to acquire multiple different wearable bands to have different themes. In performance of the theme coordination method 600, the information device 100 may present one or more thematic elements 410 to correspond with at least one other thematic element 410 currently presented, or to be presented, on the band display 230. Alternatively, in performance of the theme coordination method 600, the information device 100 may present one or more thematic elements 410 to correspond with the information device 100—the correspondence may be based on at least one other thematic element 410 currently presented, or to be presented, on the information device display 130. For example, a user may indicate selection of a particular personal image for presentation on both the information device display 130 and the wearable band display 230—the same user-selected personal image may be presented on both displays 130 and 230, or the user may select two or more images, with at least one of each image presented on each display 130 and 230. A personal image is one that the user provides, such as through capture via an image capture device. Alternatively, the correspondence may be based on a visual attribute of at least a portion of the surface 105 of the information device 100, wherein the portion of the surface 105 is not associated with the information device display 130.

At least a subset of the theme coordination method 600 of FIG. 6 may alternatively or additionally be performed by the wearable band 200, which may include its own display 230. For example, the wearable band 200 may receive identification from the information device 100 and accordingly determine one or more thematic elements 410 to present on the band display 230.

Because there may often be multiple thematic elements 410 available to provide theme coordination between the information device 100 and the wearable band 200, a predetermined schedule may be utilized to update one or more thematic elements 410 presented on either or both of the interface device display 130 and the wearable band display 230. As an example, at block 614 of FIG. 6 for a US presidential theme, multiple thematic elements 410 may have been determined, with each thematic element 410 being an image of one US president. According to the predetermined schedule, which may be periodic or aperiodic, a different US president image is presented to replace a previous president image on one or more of the displays 130 and 230.

The previously described embodiments have many advantages, including: facilitation of theme coordination between a portable electronic information device and a coupled wearable band, acquisition of relevant thematic elements and updates, removal of a need to purchase or otherwise acquire multiple different wearable bands, and thematic element updating according to a predetermined schedule. All advantageous features and all advantages need not be incorporated into every embodiment.

Embodiments within the scope of the present subject matter also include tangible non-transitory computer-readable media for carrying or having computer-executable instructions or data structures stored thereon. Such computer-readable media can be any available media that can be accessed by a computing device. By way of example, and not limitation, such computer-readable media can comprise RAM, ROM, EEPROM, magnetic disk storage or other magnetic storage devices, or any other medium which can be used to carry or store desired program code means in the form of computer-executable instructions or data structures and which can be accessed by a computing device.

Computer-executable instructions comprise, for example, instructions and data which cause a computing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system, methods, and other means for accomplishing functions disclosed herein are preferably implemented in software, implementations in hardware or a combination of software and hardware are also possible and contemplated. In this description, a “computing entity” may be any computing system as previously defined herein, or any module or combination of modulates running on a computing system.

The present subject matter may be embodied in other specific forms without departing from its spirit or essential characteristics. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A portable electronic information device comprising:
a power source;
a communication interface configured to use electricity from the power source to electrically couple with a wearable band that is attachable to, and removable from, the information device;
a display;
a memory configured to store software instructions; and
a processor configured to access the software instructions from the memory to execute the accessed software instructions to:
receive identification from the wearable band via the interface;
use the received identification to determine one or more thematic elements intended to correspond with at least one visual attribute of a surface of the wearable band; and
present the one or more thematic elements on the display.

2. The information device of claim 1, further comprising an input device configured to accept user input, wherein the processor is further configured to execute the software instructions from the memory to:
provide multiple choices via the display to a user of the information device, wherein two or more thematic elements have been determined, and wherein the multiple choices relate to the two or more thematic elements;
receive user input via the input device, wherein the user input is associated with one or more of the multiple choices; and
use the user input received via the input device to select one or more thematic elements for presentation on the display.

3. The information device of claim 1, wherein the one or more thematic elements are based on a theme associated with the wearable band, and wherein the theme pertains to at least one of: a movie, a television show, a musical act, and a famous individual, a color scheme, a visual pattern, and an image.

4. The information device of claim 1, wherein the one or more thematic elements is at least one of: a color scheme, an image, and a visual pattern.

5. The information device of claim 1, wherein the information device is an intelligent watch, a fitness tracker, or a combination thereof.

6. The information device of claim 1, wherein the wearable band also includes a display, and wherein the interface device communicates via the interface to also present one or thematic elements on the band display.

7. The interface device of claim 6, wherein the one or more thematic elements presented on either or both of the interface device display and the wearable band display are updated according to a predetermined schedule.

8. A method performed by a portable electronic information device, the method comprising:
receiving identification from an electrically coupled wearable band, wherein the wearable band is attachable to, and removable from, the information device;
querying a remote server via a wireless connection by providing the identification or a representation thereof to the server;
receiving from the server information associated with one or more thematic elements intended to correspond with at least one visual attribute of a surface of the coupled wearable band;
using the received information, selecting one or more associated thematic elements; and
presenting the selected one or more thematic elements on a display of the portable electronic information device.

9. The method of claim 8, further comprising:
providing multiple choices via the display to a user of the information device when the server information indicates two or more thematic elements, wherein the multiple choices relate to the two or more thematic elements;
receiving user input via an input device of the information device, wherein the user input is associated with at least one of the multiple choices; and
selecting at least one thematic element for presentation on the display based upon the user input received via the input device.

10. A wearable band comprising:
an interface configured for electrically coupling to a portable electronic information device, wherein the wearable band is configured to communicate via the interface with the electrically coupled information device, wherein the interface communication is used by the information device, the wearable band, or both to instantiate thematic coordination between the wearable band and the information device.

11. The wearable band of claim 10, wherein the wearable band is configured to be attachable to, and removable from, the information device.

12. The wearable band of claim 10, wherein the wearable band is integrated with the information device and therefore is not intended to be easily removable by a user.

13. The wearable band of claim 10, further comprising a display, wherein the band display is separate from any display of the information device.

14. The wearable band of claim 13, wherein the thematic coordination is instantiated by the information device presenting one or more thematic elements on a display of the information device, wherein the one or more thematic elements are determined by the information device to correspond with at least one other thematic element currently presented, or to be presented, on the wearable band display.

15. The wearable band of claim 13, further comprising:
a memory configured to store software instructions; and
a processor configured to access the software instructions from the memory to execute the accessed software instructions to:
receive identification from the information device via the interface;
use the received identification to determine one or more thematic elements intended to correspond with at least one visual attribute of a surface of the information device; and
instantiate the thematic coordination by presenting the one or more thematic elements on the band display.

16. The wearable band of claim 13, wherein the thematic coordination is instantiated through the information device communicating via the interface to cause the presentation of one or more thematic elements on the band display, wherein the one or more thematic elements are selected by the information device to correspond with the information device.

17. The wearable band of claim 16, wherein the one or more selected thematic elements are selected by the information device to correspond with at least one other thematic element currently presented, or to be presented, on a display of the information device.

18. The wearable band of claim 17, wherein the one or more selected thematic elements presented on the band display and the at least one other thematic element presented on the information device display are associated with a user-selected personal image.

19. The wearable band of claim 16, wherein the one or more selected thematic elements are selected by the information device to correspond with a visual attribute of at least a portion of a surface of the information device, wherein the portion of the surface is not associated with a display of the information device.

20. The wearable band of claim 10, wherein the thematic coordination is instantiated by the wearable band, by the information device, or by both through presentation of one or more thematic elements, wherein the one or more thematic elements are at least one of: a color scheme, an image, and a visual pattern.
